(19) United States
(12) Patent Application Publication
(10) Pub. No.: US 2016/0307118 A1
(43) Pub. Date: Oct. 20, 2016

(54) SYSTEM AND METHOD OF TELEMATICS ENQUIRY FOR OPTIMIZATION IN BOOKING MANAGEMENT

(71) Applicant: TRAPITT TECNOLOGIAS, S.L., Madrid (ES)

(72) Inventors: Daniel DE CARVAJAL AGUILAR, Madrid (ES); Luis MARTIN LAZARO, Madrid (ES)

(21) Appl. No.: 14/685,687

(22) Filed: Apr. 14, 2015

(51) Int. Cl. G06Q 10/02; H04L 29/06; H04W 84/12; H04L 29/08

(52) U.S. Cl. CPC G06Q 10/02; H04L 67/22; H04L 67/42; H04W 84/12

(57) ABSTRACT

It is an object of the present invention to provide a system and a method of telematics enquiry for optimization in booking management by which the conditions of a booking are consulted and monitored in order to obtain an advantage in the improvements of the same. In order to be able to consult and monitor the sources of information of the service providers, the present invention launches as many enquiries to the service providers as bookings are required to be managed through a private network of at least four nodes which in turn is connected to a public network (WAN-Internet) such that the service provider receives the different enquiries associated with the same booking from different nodes of the public network.

### FIELD OF THE INVENTION

The present invention is related to a system and a method of telematics enquiry for optimization in booking management. The system and the method allow monitoring and managing bookings by means of the access to the booking provider through the Internet. Therefore, this is an invention within the field of devices and methods for treating information or digital calculation, specially adapted to specific functions, as well as digital transmission.

### BACKGROUND OF THE INVENTION

Nowadays, there are many systems and methods that enable a user to remotely access a service provider like, for example, the method for controlling communications between a service provider and a user described in the

European Patent Application with publication number EP2381371A1 and entitled “Booking method and system”.

There are also many methods and systems which make possible that the transaction between user and service provider can be carried out in a safe way such as the ones described in the European Patent Application with publication number EP2667344A1 and entitled “Transactional services”.

Likewise, there are methods and systems that enable a user to request a booking through a broker web such as the ones described in the Patent Application US2012323742A1 entitled “Method and system for brokering services with time-dependent labor rates”.

However, in the state of the art there is not a booking broker that allows managing the evolution of a booking such that if a user makes a booking and, subsequently, the conditions of the booking are improved (for example, the cost is reduced), the user benefits from it.

### SUMMARY OF THE INVENTION

It is an object of the present invention to provide a system and a method of telematics enquiry for optimization in booking management by which the conditions of a booking are consulted and monitored to obtain an advantage in the improvements of the same.

In order to be able to consult and monitor the sources of information of the service providers, the present invention launches as many enquiries to the service providers as bookings are required to be managed through a private network of at least four nodes which in turn is connected to a public network (WAN-Internet) such that the service provider receives the different enquiries associated with the same booking from different nodes of the public network, which guarantees the authenticity of the information and the non-rejection by the sources of information. This is carried out by the method and the system of telematics enquiry for optimization in booking management of the present invention.

In a first aspect of the present invention, a method of telematics enquiry for optimization in booking management is provided, which comprises:
i) receiving, from a user, a subscription request in the Subscriptions module, where the subscription comprises identifying information of a booking, the identifying information of the booking comprising at least: type of product (plane ticket, ship, lodging, etc.) and the price of the booking; the identifying information of the booking, optionally and additionally for the case of plane bookings, comprises an univocal identifying code, typical data according to the type of booking such as origin and destination, stopovers, flights, routes;
ii) obtaining, from the user or from a Gateway Integration module, the conditions associated with the booking, where the conditions are at least: cancellation cost and cancellation time;
iii) obtaining, from an Action protocols module, business rules and action protocols to be applied to the subscription;
iv) sending, to a Sampling module, the subscription, the conditions associated with the booking, the business rules and the action protocols to be applied to the subscription;
v) sending, through the Control and Management module of sources of information, enquiries to the sources of information in order to obtain a new price for the booking, by means of at least one communication network, such that each enquiry to each of the sources of information is carried out by a different node of the communication network (this guarantees the authenticity of the information and the non-rejection by the sources of information);
vi) processing, by means of a Processing module, the identifying information of the booking, the conditions associated with the booking and the new price of the booking, applying the business rules when the type of product matches with the type of product of the booking in step i);
vii) blocking a new booking, by means of the Action protocols module and according to some action protocols associated with the subscription and for whose booking the business rules are obeyed (and the type of product matches with the type of product of the booking in step i)); otherwise, go back to step v);
viii) cancelling the booking in step i); and,
ix) making the booking blocked in step vii).

The Gateway integration module obtains the conditions associated with the booking by means of an enquiry to the GDS (Global Distribution System) system.

In one or more embodiments of the invention, step i) can additionally comprise a sub-step where the subscription request is stored in a subscription database.

In one or more embodiments of the invention, step iv) can additionally comprise a sub-step where it is checked if there is a sampler (entity that carries out the enquiry about the price of a given service (for example, a flight) and rate, and which has from 1 to n subscriptions associated with it, through the sources of information) for the booking and, if it does not exist, then one is created; all of the above is carried out by the Sampling module.

In one or more embodiments of the invention, step iv) can additionally comprise another sub-step where the Sampling module sends the sampler to the Control and Management module of sources of information.

In one or more embodiments of the invention, step v) can additionally comprise a sub-step where the Sampling module stores in a historical data database the new price obtained by the enquiry to the sources of information.

In one or more embodiments of the invention, step v) can additionally comprise a sub-step where the enquiries to the sources of information are carried out simultaneously in the case of at least two sources of information by means of an Manager executing enquiries simultaneously. The previous sub-step additionally comprises implementing the Manager executing enquiries simultaneously in a private network composed of four nodes and with connection to WAN public networks (Internet).

In a second aspect of the present invention, a system of telematics enquiry for optimization in booking management is provided, which comprises at least:
a client system;
a Booking Optimization Central system;
a set of servers that form a private network;

wherein the Booking Optimization Central system is connected to the client system and to the set of servers that form a private network which in turn is connected to sources of information (which contain at least information for a booking registered in the system and its corresponding identifying information, such as product and price) by means of the WAN network; and such that a user can telematically consult and optimize the booking.

The Booking Optimization Central system comprises in turn:
a Subscriptions module;
an Action protocols module;
a Sampling module;
a Foreign currency Management module;
a System Monitoring module;
a System Administration and Management module;
an Statistics module;
a Subscription database;
a historical data database;
a processing module which has at least one business rules engine;
administration and configuration web;
service publication bus.

The client system comprises, or may comprise, a BackOffice system, a WorkFlow system, an Interface Layer with GDS and third parties and a Gateway Integration module, where the client system connects with the Booking Management systems by means of the Interface Layer, which may be with GDS o third parties.

The set of servers that form a private network comprise an Enquiry Control and Management module, which comprises in turn a Manager executing enquiries simultaneously in charge of executing and controlling the information extraction processes of the booking (called “Information agents”), by means of launching enquiries to the sources of information accessible through WAN (Wide Area Network) networks.

### BRIEF DESCRIPTION OF THE DRAWINGS

FIG. 1 shows a block diagram with an embodiment example of the system of telematics enquiry for optimization in booking management.

FIG. 2 shows a flowchart with an embodiment example of the method of telematics enquiry for optimization in booking management.

### DETAILED DESCRIPTION OF ILLUSTRATIVE EMBODIMENTS

The system and method of telematics enquiry for optimization in booking management in the present embodiment example is aimed at finding a price for a booking that is lower than a price for a booking initially contracted. In the present embodiment example, the system of the present invention is described according to an implementation by several modules interconnected with each other. Thus, it only provides a functional description of the modules, which, in combination with the general technical requirements described below, is enough for one skilled in the art to carry out the embodiment example described below.

The general technical requirements, with respect to the services, are: i) the services supported are Web Services, according to the SOAP, WSDL standards; ii) support for the security electronic certificates X509; iii) the interfaces offered to clients (Search engines, aggregators, travel agencies, corporations, etc.) follow the OTA standard; iv) all the SQL statements which are needed must be compatible with the SGRBD ORACLE as well as with MYSQL in the case of SQL databases, and Cassandra in the case of NoSQL storage; v) a Framework such as “Spring” or the like is used; vi) the bookstores used to make reports, access to information, files, etc., are of wide use and recognition in the market; vii) a platform is used with support of massive information processes or also called Big Data systems such as Hadoop; viii) tools and bookstores of wide use and recognition in the market will be used to carry out sample tests and continuous integration.

The general technical requirements, with respect to systems, networks and communication infrastructures, are: i) a system infrastructure for the Booking Optimization Central system can be in mode PaaS (AWS type) or LaaS created ad-hoc, ii) furthermore, the system is mounted over a Big Data infrastructure of Acquisition and massive processing of information, such as Hadoop plus SQL and NoSQL databases, such as ORACLE/MySQL for the first type and Cassandra for the second type as has been mentioned before, iii) the system also has the following sub-systems or products; Apache as web server, JBOOS as applications server, with fault redundancy; iv) Framework Spring, Hibernate, Axis, necessary for carrying out the development; v) the communications are made via the Internet and can be encoded (https) or not; vi) the algorithms used in the encoded communications are the ones known in the state of the art.

Additionally, the system interacts with other systems, which are:
Client System (Search portal, travel agency, card operators, corporations, etc.). It represents the different clients integrated in the system, by means of the integration with its systems for them to manage and obtain a discount for the tickets. These can be travel agencies portals, search engines, credit card companies, ERP from corporations, etc. Therefore, their main function is to ask the system to obtain a better price for a ticket already bought, or to notify them, or to buy, according to an agreement, a ticket with given determinants, and cancel the previous one subsequently. The clients must carry out the integration with the system from their own systems, using the interfaces offered to that effect, which will follow the standards widely followed in the market nowadays.
Passengers (People or company on whose name the ticket is issued). This actor is the one the booking is associated with and the one by which the registration PNR (“Passenger Name Record”) must be made in a Source of Information (GDS). This PNR sent by the client does not contain the user's personal data, since the system does not need it. This actor may or may not interact with the system, depending on what is selected by the client through which the booking has been managed.
Users, these are the users of the Booking Optimization Central system, which, through its management web, consult their subscriptions, the subscription's state, and configure the profiles of Passengers managed by the Booking Optimization Central system.
Booking management systems or GDS (“Global Distribution System” such as Amadeus 601, Galileo 602, etc.), integration systems of third parties, or owned by the client, such as BackOffice systems. This actor is the one in charge of providing the interfaces for being able to carry out purchase actions, bookings, cancellations and annulments, automatically. This actor may be one or several, depending on the Sources of Information (GDS) 601-602 o third parties 603, to which the system has to access to obtain the information of the booking the clients wish to manage and act upon it. For each GDS or third party Source of Information, it is necessary to modify the Action protocols module and carry out the integration as such.
Sources of Information. This actor participates in the system, by means of enquiries, to provide the information of the product, its prices, etc. These sources of information may be from interfaces offered by GDS, enquiry web services from third parties, public information stored in the web, etc.
Administrator.

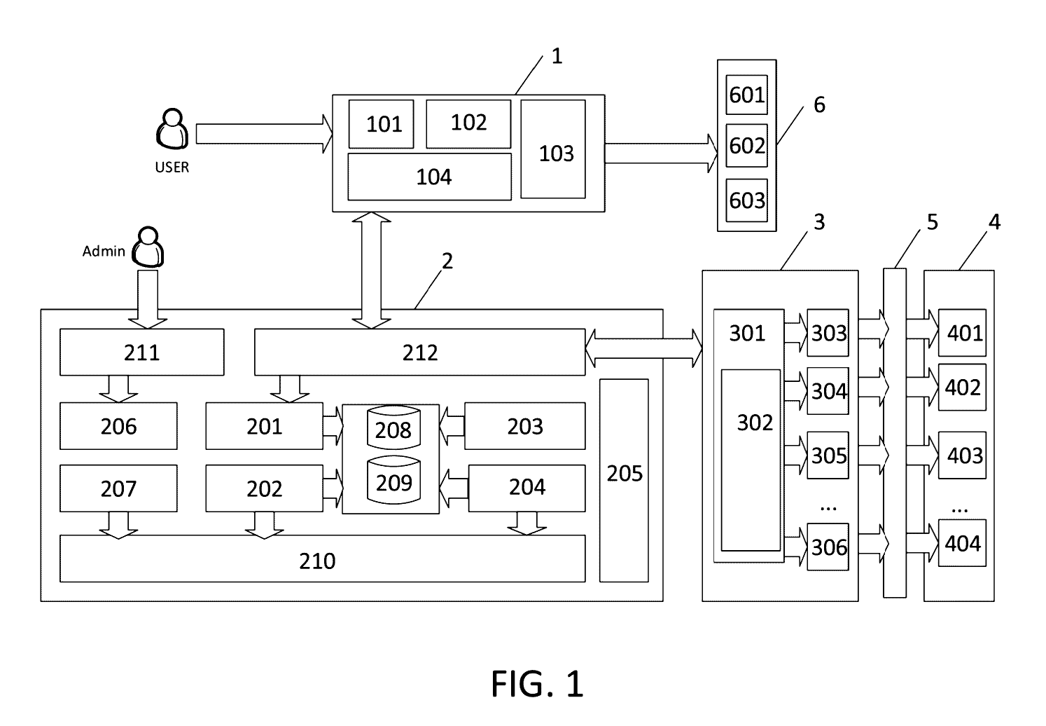

The system of telematics enquiry of the present invention, in the embodiment example shown in FIG. 1, comprises:
a client system 1;
a Booking Optimization Central system 2;
a set of servers that form a private network 3;

The client system 1 comprises in turn a BackOffice system 101, a WorkFlow system 102, an Interface Layer with GDS and third parties 103 and a Gateway Integration module 104.

The Gateway Integration module 104 is the one in charge of encapsulating the necessary calls to the API or services from the integrated

GDS operators and third parties interacting with the module of Interface Layer with GDS and third parties 103, or applications from clients such as BackOffice, etc. necessary for carrying out actions of purchase, cancellation, blocking, etc., hiding the complexity from the operative modules, to which it offers the functionality in one single call. Also from this module, the integration may be made by means of messaging with applications from the client such as queues of messages of Workflow systems or mail, etc.

The Gateway Integration module 104 has the following functional requirements: i) it is lodged in the client systems, so that it can interact with the systems of the same, showing secured interfaces, by means of web services; ii) the interfaces to be shown represents the functions necessary for the Actions of the Action protocols, as well as services destined to the validation of conditions found by means of the enquiries to the booking management system (GDS); iii) it is divided in sub-modules depending on the GDS or third party providing the functionality, or sub-modules integrated with BackOffice applications, the tourist sector, or others related to, for example, WorkFlows; iv) it carries out the actions of purchase, booking, blocking, unblocking, cancellation, etc., against the corresponding booking management system (GDS or third party), which needs the remaining components of the system; v) it has a function for each type of action necessary for the action protocols module, encapsulating within this function all the calls necessary to make said operation against the corresponding booking management system (GDS or third party); vi) every execution of an action must be framed in a framework of transactionality, whether provided directly by the booking management system (GDS or third party), or by the client system 1, or whether a booking action has a booking cancellation, and a blocking action has a blocking cancellation, etc.; vii) it knows to which booking management system (GDS or third party) it must call interacting with the Interface Layer with GDS and third parties, in order to carry out the validation operations of conditions obtained from the sources of information, cancellations, new purchases, etc.

The set of servers that form a private network 3 have an Enquiry Control and Management module 301 implemented. This enquiry control and management module comprises a Manager executing enquiries simultaneously 302 in charge of executing and controlling the information extraction processes of the booking. The information extraction processes of the booking are called “Information agents” 303-306 and they carry out the launching of enquiries to the sources of information 4 (401-404) accessible through WAN (wide area network) networks 5.

The Enquiry Control and Management module 301 is the one in charge of managing all the necessary enquiries so that it offers the necessary functionality to the Sampling module and at the right time. This module runs in a set of servers that will form in turn the private network. In this module, and subsequently upon request of the client, the necessary calls to the API or the services of the integrated GDS operators necessary to obtain information from the booking (availability, price, etc.) can be encapsulated, as well as rate conditions associated with the same, and other information necessary to carry out the sampling operations also as sources of information, or as a validating entity of everything found through other sources of information, hiding the complexity from the operative modules, to which it will offer the functionality in one single call.

The Enquiry Control and Management module 301 has the following functional requirements: i) it obtains the information necessary of each booking (availability, price, etc.), conditions associated with the rates, etc., of the integrated sources of information, needed by the remaining modules of the system; ii) it executes and controls the information extraction processes of the booking from the sources of information by means of a Manager executing enquiries simultaneously 302. To that end, it publishes a service that allows at least the following operations: (a) Activating/Deactivating enquiry requests; (b) Obtaining the sampling errors by enquiry (total, percentage, etc.); (c) Activating/Deactivating the sampling operation as a whole; iii) the Enquiry

Control and Management module is executed over a system of high availability and it stores the information obtained in a redundant way; iv) in this module, and subsequently upon request of the client, the necessary calls to the API or the services of the integrated GDS operators necessary to obtain information from bookings (availability, price, etc.) can be encapsulated, in order to carry out the sampling operations as another Source of Information. The calls to the Sources of Information (GDS's) are made through the Gateway Integration module that is installed in the clients; iv) it is established over a private ToR network, initially composed of at least four nodes mounted over a system architecture for Big Data; v) each node is mounted by means of a script or with a copy of the complete system from an image, such that the installation of a new node is an easy task; vi) it manages the caching of information, that is to say, if some information has been consulted less than a parametrizable time ago by type of data, instead of invoking the GDS Source of Information, it recovers said information that is in the historical data information database, o in memory (if the cache management in memory is enabled); vii) it implements the PRP protocol and publishes a service (REST, WebService) that enables the subscription, cancellation and notification of price changes in booking types; viii) it stores the booking information extracted by the enquiries to the Sources of Information in each iteration; ix) it provides a development API (Application Programming Interface) and types of support with the intention of facilitating the development of enquiries to the Sources of Information by third parties; x) it manages the configuration of the enquiries to the Sources of Information in charge of extracting the booking prices by means of parameters: (a) number of enquiries to the Sources of Information to be executed by node; (b) maximum bandwidth a set of enquiries to the Sources of Information may use over a node of the private network of output nodes toward the public WAM network; (c) maximum bandwidth to be used by node; (d) maximum number of requests a set of enquiries to the Sources of Information may use over the information origin; (e) enquiry report of the Sources of Information with errors (enquiries to the Sources of Information that by some reason are failing in their task); (f) configuration of the sampling regularity of the enquiries to the Sources of Information by information origin (provider); (g) the previous regularity could also be according to routes and dates of the bookings; xi) it comprises a layer for the control, management and installation of the enquiries to the Sources of Information that must be mounted over these nodes, the requirements of this layer being: (a) guaranteeing that every enquiry from the consuming applications will have an answer; (b) carrying out the load balancing to ensure defined response times; (c) for all the abovementioned, it raises and controls the number of petitions necessary for each existing enquiry according to demand; (d) it offers information about the number of raised petitions, number of requests attended each minute by each petition, petition state (if they are failing, giving a warning or ok), etc., to the System Monitoring module 205 of the client applications.

The system has the following requirements associated with the Information Agents that carry out the enquiries against Sources of Information: i) the Information agents may be added to the system by means of a plug-in architecture without the need to reinstall or compile again the whole system; ii) a series of enquiries are made to attack the Sources of Information, and the enquiries meet the following general requirements: (a) having a list of Sources of Information by priority order; (b) for all the enquiries, the following information is received by parameter, for example, in the case of flight bookings: (I) outward flight, or round-trip flight; (II) origin IATA code; (III) destination IATA code; (IV) date and departure time; (V) date and return time (only in the case of round-trip flight); (VI) outward flight code; (VII) destination flight code; (VIII) class type (upper tourist class, business class, first class); (IX) when looking for direct flights or also with stopovers; (c) the enquiries introduce into the Sources of Information the parameters needed by each Source of Information, starting from those indicated by the applications, and the result will be the current price for that booking, this price being returned in the answer to the application simultaneously.

The Booking Optimization Central system 2 comprises in turn:
a Subscriptions module 201;
an Action protocols module 202;
a Sampling module 203;
a Foreign currency Management module 204;
a System Monitoring module 205;
a System Administration and Management module 206;
an Statistics module 207;
a subscription information database 208;
a historical data information database 209;
a processing module with a business rules engine 210;
administration and configuration web 211;
service publication bus 212.

The Subscriptions module 201 offers, on the one hand, the interfaces so the client web systems (own or external, and that are integrated telematically with the Booking Optimization Central 2) may obtain information about how the system works by invoking the System Administration and Management module 206. On the other hand, the Subscriptions module 201 also offers an interface in which the client systems may register user bookings to try to save or obtain a discount, as well as another service in charge of executing actions configured in the system for the action protocol associated with this client, against the “Gateway” integration module, which is in charge of carrying out the integration with third parties such as the booking management systems like GDS's, whether directly or through access layers owned by the client, or also by means of the integration with BackOffice systems from the client, as well as sending warnings to clients (or users of web applications) when the conditions have been met.

The Subscriptions module 201 has the following functional requirements: i) it carries out a booking subscription (for example, round-trip flight or with stopovers, a hotel, a ferry, a train, etc.), by one of the clients of the system, establishing the determinants by price, as well as the action protocols associated with each type of event of a subscription, as can be the action protocol to be performed if the conditions are met or not; ii) it registers the action protocols to be performed in the case of the remaining events such as subscription expiration, expiration of the maximum time for booking blocking, etc.; iii) the action protocols to be associated with each event of a subscription must be parametrized in the system and may also be configured by client, so that the action protocols may be associated automatically when creating a subscription; iv) the action protocol that has a subscription associated with it belongs to the ones pre-established in the system, and is according to the cancellation costs of the ticket, whether or not it can be blocked, the amount of time it may remained blocked (2 hours, 24 hours, etc.). This information is obtained through the System Administration and Management module 206, as well as from the information itself sent in the subscription (all the information of the PNR without personal information), or it is obtained by means of the interaction with the Gateway integration module, which, in turn, will obtain it from a third party, whether source of information or GDS; v) the action protocols to be associated with this subscription are four, and are associated with the events of the subscription: (a) one, in case the price condition with bought ticket is met; (b) another, in case the condition with blocked ticket is met; (c) another, to be executed in case of reaching the blocking maximum time (minus a security gap), for example, in the case of flight bookings, for buying the ticket; (d) another, to be executed in case of reaching the end of the sampling subscription period; vi) a subscription is associated with at least the main action protocol associated with the compliance with the price condition with bought ticket, while the three other action protocols are fulfilled if booking blockings are enabled and, as optional, the one about the end of the sampling period; vii) each action protocol is composed of atomic actions from the business point of view, as may be cancelling, blocking, buying, informing, integrating with

Backoffice, sending mail, etc.; viii) the determinants associated with a subscription, that must be checked if they are met, are associated with business rules in order to be able to configure, without reprogramming again, changes in the way of complying with these determinants. For example, the formula used to establish the objective price is: Objective Price=Initial Price -(Operative gap +Cancellation cost); ix) a subscription may be carried out by establishing as determinant the price of the ticket; x) the Sampling module 203 is the one in charge of checking if the determinants are met each time information has been obtained for a booking and a rate. If this is met, the Sampling module will invoke the Subscriptions module 201 to check if other determinants are also met, as may be a change of rate, or others; xi) the moment in which a subscription determinants are met is also saved in the historical data information database 209; xii) the information obtained is compared with the determinants thanks to the Sampling module 203 applying the business rules to the determinants (in the case of the price, it will be the formula associated with the condition of the subscription, which will have passed it from the Subscriptions module once it has calculated the objective price by means of the configured formula, to the Sampling module in order for this one to compare it directly; xiii) if all the determinants are met, this module invokes the Action protocols module to carry out the action protocol associated with the subscription and that was indicated by the client; xiv) each one of these fulfillments of complete subscriptions are registered in the sampling historical data information database; xv) in case the booking they refer to is not contemplated in the system, a message will be returned to the client indicating this fact; xvi) the system, in case the subscription is valid, will register said information in the subscription information database 208; xvii) for each subscription, an expiration action protocol may also be configured, which is executed in case it has been updated and if the maximum time of validity for this subscription has been reached, but not completely. In order to carry out this execution, a call is made from the Subscriptions module to the Action protocols module; xviii) once the time of validity of a subscription has been reached (it will normally be the launching time of the booking minus a predefined value for each client/ source of information, for example, although it is parametrizable by the client), the action protocol associated with the end of the sampling period is executed, which, in this case, is the delivery of a message giving a warning to the user; xix) this module also has a functionality that is executed once it has been checked that the price obtained for this booking-rate by the Information Agent is in compliance with the conditions of the subscription, the conditions of the subscription are verified against a Source of Information (GDS or another third party), since there is the possibility of an error occurring with the Information Agent. This call is made directly from this Subscriptions module to the Gateway Integration module, which invokes a third party, whether GDS or another telematics interface.

The Sampling module 203 is in charge of launching the samplers necessary for being able to obtain the information necessary from the enquiry Control and Management module 301, in order to be able to subsequently check this values with the objective prices provided by the Subscriptions module 201, in case the price obtained is equal or lower than the objective price, the Subscriptions module 201 is invoked, and it checks if the determinants associated with each subscription are met. There may be several subscriptions associated with one sampler, and each subscription will have different determinants, such as the objective price.

The Sampling module 203 has the following functional requirements: i) a sampling is a process that is launched periodically with a variable regularity according to the information origin, route, travel dates or booking, etc., for example, in the case of plane bookings, and periods, cities, etc., in the case of hotel bookings, and the same with the rest of the bookings, to check that the registered subscriptions are fulfilled; ii) a sampling may check several subscriptions at the same time, if they are from the same booking and the same type of booking; iii) the Sources of Information that have to be invoked are defined by a parameter determined by the system. This parameter is sent to the enquiry Control and Management module 301 so it may know where to obtain the information; iv) the types of “sources of information” to which the system can access are: (a) GDS's such as Amadeus, Sabre, etc. (access by means of the integration with the client through the Gateway Integration Module); (b)

Information agents that sample different types of telematics interfaces to obtain information; v) the execution times of the samplings are configurable by source of information, dates and type of booking; vi) the information about when to start sampling, until when and the regularity by time intervals by information origin, dates and type of booking are configurable in the system; vii) once the subscriptions are registered, the system launches a sampler for each subscription invoking the sampling module, or the system associates the subscription with a sampling already existing if it is in compliance with the rules of being associable, such as a sampling for the same source of information and type of booking; viii) the price condition is established in the subscription, and is defined by a formula established in the form of a business rule according to information origin and rate type; ix) this module makes a call to the interface of the enquiry control and management module for this one to return the result of the price and information necessary such as the rate for the price found, or invokes the Gateway integration module, in which the flows of calls necessary for each integrated GDS are encapsulated, so that the information offered to the Sampling module always has the same form and content regardless of the source of information providing it. All the information recovered in this way from the source of information will be registered in the Historical data Information Database 209, to make statistical calculations about said information subsequently, and be able to offer them to the client by means of the Statistics module 207 at the time of a subscription, for example, the success rate of said subscription, for example, or also make enquiries to provide services to clients when real time information is not wanted; x) the information to be recorded will be the one relating it to the subscription or subscriptions to which the samplings are associated, the type of rate and the one related to the price that is taking for each type of booking and time and day of the sampling.

The Action protocols module 202 is the one in charge of carrying out the management and execution of the action protocol associated with a subscription, with the execution of each one of the actions composing it against, for example, the GDS o third party, or Backoffice systems of the client, through the Gateway integration module. There may also exist other actions, such as the delivery of warnings by messaging systems, mail, etc.

The Action protocols module 202 has the following functional requirements: i) it carries out the management of the actions associated with one type of action protocol; ii) each one of the actions has a function parametrized to invoke the interface of the Gateway Integration Module; iii) there may exist other actions such as the delivery of warnings by messaging systems, mail, etc.; iv) the Gateway Integration Module encapsulates the calls and flows of calls that must be carried out in order to make the operation against the Source of Information (GDS or third party), or even the Backoffice applications of the client. In the Gateway Integration Module, the flows of calls necessary for each GDS integrated in the client is encapsulated, so that the information that must be sent always has the same form and content regardless of the Source of Information (GDS) providing it; v) an action is an atomic operation from the business point of view against a GDS, third party or Backoffice of the client; vi) the execution, of one action protocol with all of its actions, can optionally be framed in a framework of transactionality if this option is chosen, that is to say, either all of them are carried out or the ones that have been carried out, in case this option is in the action protocol / subscription, are undone (example for flights: a found ticket is blocked and, upon cancelling the previous one, the system cannot do it or obtains an error, the system has to make the cancellation of the previous blocking in order to try again once a configurable time has passed); vii) if an Action protocol has given an error and, once the roll-back of this Action protocol has been done this is marked as transactional, the Booking Optimization Central 2 tries again once a configurable time has passed; viii) retries by action may also be carried out once another configurable time has passed; ix) in the case of the purchase action as such, the system will always do it with the payment information associated with the user of the booking, that is to say, the PNR with which the first purchase was made in the case of Amadeus. The same thing applies when carrying out blockings.

The System Administration and Management module 206 allows configuring the functioning variables of the system, modifying the business rules of the business rules engine 210, consulting information from the Monitoring module 205, etc.

The Administration and Management module 206 has the following functional requirements: i) it has a web component to be able to administer the system remotely, regarding all the configuration parameters related to the business, and that will be obtained from the analysis and design of the system; ii) these configuration parameters, or business rules, shall be obtained by means of a business rules engine; iii) it allows the maximum business parametrizations there and then, with the integration ones (by definition) remaining to be carried out by means of restarting the system or part of it; iv) from this module, a system monitor may also be accessed.

The Monitoring module 205 allows checking the global state and the detailed state of the system, as well as consulting the events produced in the different modules, which, by means of the integration of examiners, inform about warnings, events, etc., to this module. The administration and configuration web 211 enables one or several administrators (admin) to access the Administration and Management module 206 and thus being able to manage the whole system.

The Monitoring module 205 has the following functional requirements: i) constructing the monitoring system with functionalities such as sending warnings when parametrized conditions are met; ii) all of these warnings, events and other monitoring information may be consulted from the Administration and Configuration web 211 of the Booking Optimization Central system 2; iii) also from the Administration and Configuration web 211 of the Booking Optimization Central system 2, a console may be displayed showing the enquiries requests, the number of petitions being currently taking care of, their state, the response average time, etc.; iv) parametrization of Notification conditions; v) creation of an monitoring agent, that is sampling the components of the private network, the enquiries, as well as the Booking Optimization Central system itself; vi) information is provided from the remaining modules by means of the inclusion of the monitoring agent.

By means of the service publication bus 212, the Booking Optimization Central system 2 communicates with the client system 1 and with the set of servers that form a private network 3.

The Foreign currency Management module 204 has the function of applying the change of foreign currency if necessary. For example, when user and booking have different payment currencies. This module is involved in the business rules, the subscription information database 208 and the historical data information database 209.

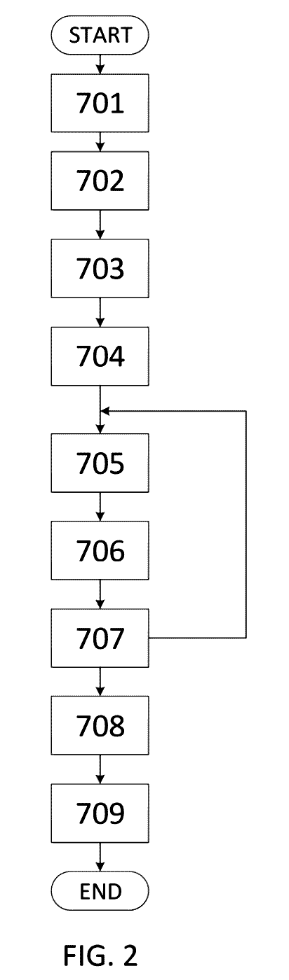

On the other hand, FIG. 2 shows the method of telematics enquiry for optimization in booking management that uses the previously described system.

The method comprises:
i) receiving 701, from a user, a subscription request in the Subscriptions module 201, where the subscription comprises identifying information of a booking, the identifying information comprising at least: type of product (plane ticket, ship, lodging, etc.) and the price of the booking;
ii) obtaining 702, from the user or from the Gateway Integration module 104, the conditions associated with the booking, where the conditions are at least: cancellation cost and cancellation time;
iii) obtaining 703, from the Action protocols module 202, business rules and action protocols to be applied to the subscription;
iv) sending 704, to the Sampling module 203, the subscription, the conditions associated with the booking, the business rules and the action protocols to be applied to the subscription;
v) sending 705, through the Control and Management module of sources of information 301, enquiries to the sources of information in order to obtain a new price for the booking, by means of at least one communication network 5, such that each enquiry to each of the sources of information 4 is carried out by a different node of the communication network;
vi) processing 706, by means of the processing module 210, the identifying information of the booking, the conditions associated with the booking and the new price of the booking, applying the business rules (when the type of product matches with the type product of the booking in step i));
vii) blocking 707 a new booking, by means of the Action protocols module 202, for which the business rules are obeyed and the type of product matches with the type of product of the booking in step i); otherwise, go back to step v);
viii) cancelling 708 the booking in step i); and,
ix) making 709 the booking blocked in step vii).

1. Method of telematics enquiry for optimization in booking management comprising:
i) receiving, from a user, a subscription request in the Subscriptions module, where the subscription comprises identifying information of a booking, said identifying information of the booking comprising at least: type of product and price of the booking;
ii) obtaining, from the user or from the Gateway Integration module, the conditions associated with the booking, where the conditions are at least:
cancellation cost and cancellation time;
iii) obtaining, from an Action protocols module, business rules and action protocols to be applied to the subscription;
iv) sending, to a Sampling module, the subscription, the conditions associated with the booking, the business rules and the action protocols to be applied to the subscription;
v) sending, through a Control and Management module of sources of information, enquiries to the sources of information in order to obtain at least a new price for the booking, by means of at least one communication network, such that each enquiry to each of the sources of information is carried out by a different node of the communication network;
vi) processing, by means of a processing module, at least: the identifying information of the booking, the conditions associated with the booking and the new price of the booking, applying the business rules when the type of product matches with the type product of the booking in step i);
vii) blocking a new booking, by means of the Action protocols module, for which the business rules are obeyed and the type of product matches with the type of product of the booking in step i); otherwise, go back to step v);
viii) cancelling the booking in step i); and,
ix) making the booking blocked in step vii).

2. The method of claim 1, wherein the Gateway Integration module obtains the conditions associated with the booking by means of an enquiry to the Control and Management module of sources of information of data, which, in turn, consults the sources of information.

3. The method of claim 1, wherein the step i) further comprising a sub-step where the subscription request is stored in a Subscription Information Database.

4. The method of claim 1, wherein the step iv) further comprising a sub-step where it is checked if there exists a sampler for the booking and, if this is not the case, one is created; all the abovementioned is carried out by the Sampling module.

5. The method of claim 4, wherein the step iv) further comprising another sub-step where the sampling module sends the sampler to the Control and Management module of sources of information.

6. The method of claim 1, wherein the step v) further comprising a sub-step where the sampling module stores, in a historical data information database, the new price obtained by the enquiry to the sources of information.

7. The method of claim 1, wherein the step v) further comprising a sub-step where the enquiries to the sources of information are carried out simultaneously in the case of at least two sources of information by means of a Manager executing enquiries simultaneously.

8. The method of claim 7, wherein said sub-step further comprising implementing the Manager executing enquiries simultaneously in a private network composed of four nodes and with connection to WAN public networks.

9. System of telematics enquiry for optimization in booking management comprising:
a client system;
a Booking Optimization Central system;
a set of servers that form a private network;
wherein the Booking Optimization Central system is connected to the client system and to the set of servers that form a private network which in turn is connected to sources of information, which comprise at least one booking, by means of the WAN network; and such that a user can telematically consult and optimize the booking.

10. The system of claim 9, wherein the Booking Optimization Central system comprises:
a Subscriptions module;
an Action protocols module;
a Sampling module;
a Foreign currency Management module;
a System Monitoring module;
a System Administration and Management module;
an Statistics module;
a subscription information database;
a historical data information database;
a processing module which in turn comprises a business rules engine;
administration and configuration web; and, service publication bus.

11. The system of claim 9, wherein the client system comprises a BackOffice system, a WorkFlow system, an Interface Layer with GDS and third parties and a Gateway Integration module, where the client system connects with sources of information by means of said Interface layer with GDS and third parties.

12. The system of claim 9, wherein the set of servers that form a private network comprise an enquiry Control and Management module, which, in turn, comprises a Manager Executing Enquiries simultaneously in charge of executing and controlling information extraction processes of the booking, by means of launching enquiries to the webs of sources of information accessible through WAN networks.
